(19) United States
(12) Patent Application Publication
(10) Pub. No.: US 2004/0100746 A1
(43) Pub. Date: May 27, 2004

(54) Silocon-controlled rectifier with dynamic holding voltage for on-chip electrostatic discharge protection

(75) Inventors: Zi-Ping Chen, Hsinchu (TW); Chyh-Yih Chang, Hsinchu (TW); Ming-Dou Ker, Hsinchu (TW)

Correspondence Address: Finnegan, Henderson, Farabow,, Garrett & Dunner, L.L.P., 1300 I Street, N.W., Washington, DC, 20005-3315, US

(73) Assignee: Industrial Technology Research Institute.

(21) Appl. No.: 10/726,490

(22) Filed: Dec. 4, 2003

Related U.S. Application Data
(63) Continuation-in-part of application No. 10/400,874, filed on Mar. 28, 2003.
(60) Provisional application No. 60/427,946, filed on Nov. 21, 2002.

(51) Int. Cl. H02H 9/00

(52) U.S. Cl. 361/56

(57) ABSTRACT

An integrated circuit for electrostatic discharge (ESD) protection that comprises a silicon-controlled rectifier (SCR), a first transistor of a first type integrally formed with the SCR including a first gate, a second transistor of a second type integrally formed with the SCR including a second gate, and a control circuit in response to a first voltage applied to the first and second gates providing a first holding voltage to the SCR to keep the SCR from latching-up, and in response to a second voltage applied to the first and second gates providing a second holding voltage to the SCR to keep the SCR in the latch-up state.

### RELATED APPLICATION

This application is a Continuation In Part of U.S. application Ser. No. 10/400,874 filed Mar. 28, 2003, whose content is incorporated herein by reference in its entirety.

### DESCRIPTION OF THE INVENTION

1. Field of the Invention

This invention pertains in general to a semiconductor device and, more particularly, to an electrostatic discharge protection device that is immune to latch-up during normal operations.

2. Background of the Invention

A semiconductor integrated circuit (“IC”) is susceptible to an electrostatic discharge (“ESD”) event, which may cause damage to the IC, such as one with advanced metal-oxide-semiconductor (“MOS”) transistors. Advanced MOS transistors have traditionally required certain properties such as short channel lengths, low threshold voltages, and thin gate oxide layers. These MOS transistors, manufactured using quarter-submicron complemental metal-oxide-semiconductor (“CMOS”) processes with lightly-doped drain (“LDD”) structures and clad silicide diffusions, are more vulnerable to ESD.

An ESD event is an electrical discharge of a current (positive or negative) for a short duration during which a large amount of current is provided to the IC. The high current may be built-up from a variety of sources, such as the human body and machines, referred to as the human body model (“HBM”) and machine model (“MM”), respectively. An IC is susceptible to the HBM and MM built-up during fabrication, transportation, or handling.

Conventional ESD protection structures manufactured with CMOS processes generally include NMOS/PMOS transistors, silicon-controlled rectifiers (“SCRs”), diodes, resistors, field-oxide devices (“FODs”) and parasitic vertical/lateral bipolar junction transistors (“BJTs”). Among the conventional ESD protection structures, SCR is able to sustain a high ESD current in a relatively small layout due to its inherent characteristics, one of which being low holding voltage. However, a general CMOS fabrication process for the formation of the SCR will likely involve power supply voltages higher than the holding voltage associated with the SCR. For example, a conventional SCR typically has a holding voltage of approximately 1 volt, while the power supply voltage may range from 2.7 to 5 volts. As a result, a latch-up or transient latch-up SCR caused by an ESD event may not be turned off. Moreover, SCRs are liable to latch-up or transient latch-up during normal operations due to noise such as a power surge or spike. Upon an SCR latch-up during normal operations, an IC to be protected by the SCR ceases to function properly or may even be permanently damaged.

Many techniques have been proposed to prevent SCRs latch-up. An example is shown in FIG. 1. FIG. 1 is a reproduction of FIG. 4 of U.S. Pat. No. 6,031,405 (hereinafter “the '405 patent”) to Yu et al., entitled “ESD Protection Circuit Immune to Latch-up during Normal operations.” The '405 patent describes an ESD protection circuit that includes an SCR and an ON/OFF controller. The SCR is coupled between an IC pad and a grounding node to form an ESD path. The ON/OFF controller is coupled to a cathode of the SCR. During normal operations, the ON/OFF controller disconnects the ESD path to avoid latch-up even if noise interference occurs.

However, in view of the fact that an ESD current flows through a switch transistor M1 as well as an SCR, the ON/OFF controller would need to be made large enough to allow passage of a large ESD current. Transistor M1 that occupies a large chip area is not economically acceptable and impracticable in today's limited layout area required for an ESD protection device.

Another example of a conventional technique is shown in FIG. 2. FIG. 2 is a reproduction of FIG. 4a of U.S. Pat. No. 6,172,404 (hereinafter “the '404 patent”) to Chen et al., entitled “Tunable Holding Voltage SCR ESD Protection.” The '404 patent describes an SCR that includes an n⁺ region 40 in an N-well of the SCR. A resistor 50 is formed between a base of a pnp parasitic bipolar transistor and n⁺ region 40. Resistor 50 allows more current to flow through and thus makes the pnp bipolar transistor difficult to turn on. As a result, the holding voltage associated with the SCR is increased. The amount of the holding voltage depends on the location of n⁺ region 40 formed in the N-well.

Although the '404 patent is able to raise the holding voltage of the SCR to above a power supply voltage, Vdd, such a holding voltage is not adjustable once it is determined. An SCR with such a fixed, high holding voltage is unable to sustain a large ESD current. In addition, other things being equal, an SCR with a high holding voltage generates more heat than one with a low holding voltage. Further, an SCR with a high holding voltage usually clamps ESD stress at a voltage higher than the power supply voltage Vdd, causing potentially destructive effects on internal circuits.

### SUMMARY OF THE INVENTION

Accordingly, the present invention is directed to ESD protection devices that obviate one or more of the problems due to limitations and disadvantages of the related art.

Additional features and advantages of the invention will be set forth in the description which follows, and in part will be apparent from the description, or may be learned by practice of the invention. The objectives and other advantages of the invention will be realized and attained by the devices and methods particularly pointed out in the written description and claims thereof, as well as the appended drawings.

To achieve these and other advantages, and in accordance with the purpose of the invention as embodied and broadly described, there is provided an integrated circuit for electrostatic discharge (ESD) protection that comprises a silicon-controlled rectifier (SCR), a first transistor of a first type integrally formed with the SCR including a first gate, a second transistor of a second type integrally formed with the SCR including a second gate, and a control circuit in response to a first voltage applied to the first and second gates providing a first holding voltage to the SCR to keep the SCR from latching-up, and in response to a second voltage applied to the first and second gates providing a second holding voltage to the SCR to keep the SCR in the latch-up state.

In one aspect of the present invention, the control circuit further comprises a resistor, a capacitor and an output terminal disposed between the resistor and the capacitor.

In another aspect of the present invention, the SCR further comprises a p-type substrate, an n-well formed in the p-type substrate, a p-type diffused region formed in the n-well, and an n-type diffused region formed outside of the n-well.

Also in accordance with the present invention, there is provided an integrated circuit for electrostatic discharge (ESD) protection that comprises a silicon-controlled rectifier (SCR), a p-type transistor formed integrally with the SCR, an n-type transistor formed integrally with the SCR, a control circuit coupled to the p-type and n-type transistors providing a first holding voltage to the SCR to keep the SCR from latching-up, and providing a second holding voltage to the SCR to keep the SCR in the latch-up state.

In one aspect of the present invention, the SCR is coupled between a contact pad and a voltage line.

In another aspect of the present invention, the SCR is coupled between different voltage lines.

Still in accordance with the present invention, there is provided an integrated circuit for electrostatic discharge (ESD) protection that comprises a first voltage line of a first voltage level, a second voltage line of a second voltage level, a plurality of contact pads, a plurality of silicon-controlled rectifiers (SCR), each of the SCRs including a p-type transistor and an n-type transistor integrally formed with the SCR, and a control circuit providing a first holding voltage through the p-type and n-type transistors to the SCRs to keep the SCRs from latching-up, and providing a second holding voltage through the p-type and n-type transistors to the SCRs to keep the SCRs in the latch-up state during an ESD event that an ESD pulse appears on the first voltage line or one of the contact pads.

Yet still in accordance with the present invention, there is provided a method of electrostatic discharge protection that comprises providing a silicon-controlled rectifier (SCR) having a holding voltage, integrally forming a first transistor of a first type with the SCR including a first gate, integrally forming a second transistor of a second type with the SCR including a second gate, and providing a first signal to the first and second gates to raise the holding voltage of the SCR to keep the SCR from latching up, and providing a second signal to the first and second gates to lower the holding voltage of the SCR to keep the SCR in the latch-up state.

Further still in accordance with the present invention, there is provided a method of providing electrostatic discharge (ESD) protection for internal circuits that comprises providing a first voltage line of a first voltage level, providing a second voltage line of a second voltage level, providing a plurality of contact pads, providing a plurality of silicon-controlled rectifiers (SCR), each of the SCRs including a p-type transistor and an n-type transistor formed integrally with the SCR, and providing a first holding voltage through the p-type and n-type transistors to the SCRs to keep the SCRs from latching-up, and providing a second holding voltage through the p-type and n-type transistors to the SCRs to keep the SCRs in the latch-up state during an ESD event that an ESD pulse appears on the first voltage line or one of the contact pads.

In one aspect of the present invention, the method further comprises discharging the ESD pulse from one of the contact pads via the second voltage line to the first voltage line.

In another aspect of the present invention, the method further comprises discharging the ESD pulse from the first voltage line via the second voltage line to one of the contact pads.

In still another aspect of the present invention, the method further comprises discharging the ESD pulse from one of the contact pads via the second voltage line to a different contact pad.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are incorporated in and constitute a part of this specification, illustrate embodiments of the invention and, together with the description, serve to explain the objects, advantages, and principles of the invention.

In the drawings,

FIG. 1 shows a circuit diagram of a conventional electrostatic discharge (ESD) protection device;

FIG. 2 shows a cross-sectional view of another conventional ESD protection device;

FIG. 3 shows a circuit diagram of a silicon-controlled rectifier (SCR) and a control circuit in accordance with one embodiment of the present invention;

FIG. 4 is a chart showing a current-voltage (I-V) curve of the circuit shown in FIG. 3;

FIG. 5 shows a cross-sectional view of a layout of an ESD protection circuit;

FIG. 6 shows a cross-sectional view of a layout of another ESD protection circuit;

FIG. 7 shows a circuit diagram of an SCR and a control circuit in accordance with another embodiment of the present invention;

FIG. 8 shows a layout of an ESD protection circuit in accordance with one embodiment of the present invention;

FIG. 9 shows a layout of another ESD protection circuit;

FIG. 10 shows an ESD protection circuit in accordance with one embodiment of the present invention;

FIG. 11 shows another ESD protection circuit in accordance with one embodiment of the present invention;

FIG. 12 shows an input-stage ESD protection circuit in accordance with one embodiment of the present invention;

FIG. 13 shows another input-stage ESD protection circuit in accordance with one embodiment of the present invention;

FIG. 14 shows an output-stage ESD protection circuit in accordance with one embodiment of the present invention;

FIG. 15 shows another output-stage ESD protection circuit in accordance with one embodiment of the present invention;

FIG. 16 shows an ESD protection circuit in a mixed-voltage input/output stage in accordance with one embodiment of the present invention;

FIG. 17 is a schematic circuit diagram showing ESD protection in mixed-voltage power supplies in accordance with one embodiment of the present invention;

FIG. 18 shows a circuit for mixed-voltage power supplies ESD protection using an NMOS-triggered SCR in accordance with one embodiment of the present invention;

FIG. 19 shows a circuit for mixed-voltage power supplies ESD protection using a PMOS-triggered SCR in accordance with one embodiment of the present invention;

FIG. 20A shows a cross-sectional view of an SCR in accordance with one embodiment of the present invention;

FIG. 20B shows a control circuit in accordance with one embodiment of the present invention;

FIG. 21 shows an ESD protection circuit in accordance with another embodiment of the present invention;

FIG. 22 shows an ESD protection circuit in accordance with still another embodiment of the present invention; and

FIG. 23 shows an ESD protection circuit in accordance with yet another embodiment of the present invention.

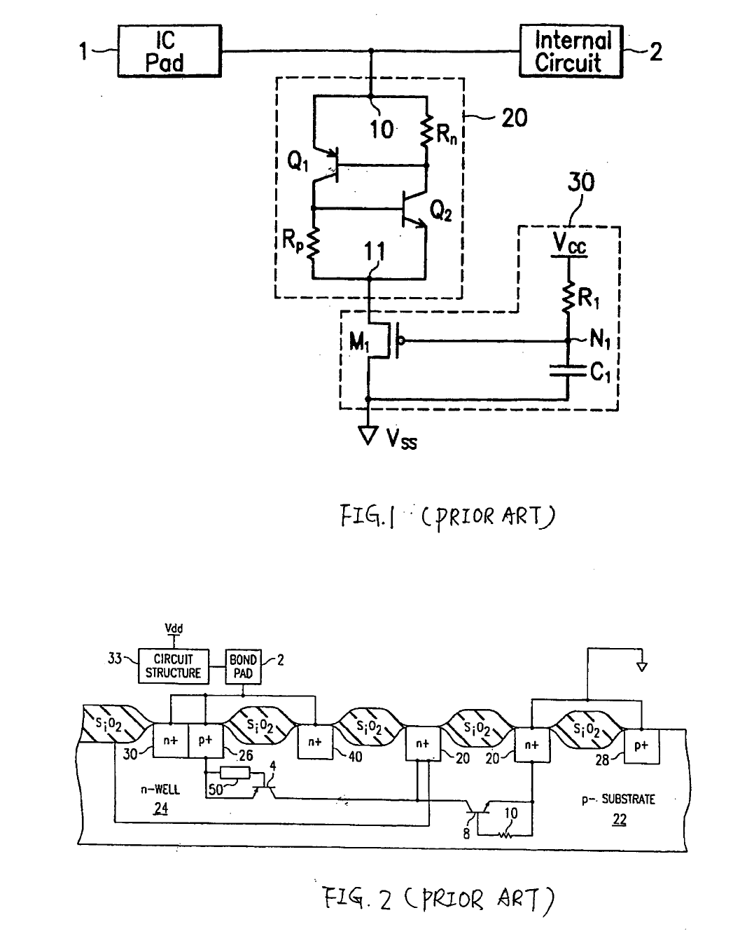

### DESCRIPTION OF THE EMBODIMENTS

Reference will now be made in detail to exemplary embodiments of the invention, examples of which are illustrated in the accompanying drawings. Wherever possible, the same reference numbers will be used throughout the drawings to refer to the same or like parts.

The present invention provides an electrostatic discharge (ESD) protection circuit that includes a silicon-controlled rectifier (SCR) and a control circuit coupled to the SCR for providing a first holding voltage of the SCR to keep the SCR from latch-up during a first condition and providing a second holding voltage of the SCR to keep the SCR in latch-up during a second condition. That is, a holding voltage of the SCR is adjustable. Specifically, the holding voltage of the SCR is raised to a first holding voltage that is above a power supply voltage to keep the SCR from latching-up during normal operations, and the holding voltage is lowered to a value below the power supply voltage to keep the SCR in the latch-up state during an ESD event.

FIG. 3 shows a circuit diagram of an SCR 60 and a control circuit 74 in accordance with one embodiment of the present invention. Referring to FIG. 3, SCR 60 includes a parasitic PNP bipolar transistor 62, a parasitic NPN bipolar transistor 64, an n-well resistor 66, a substrate resistor 68 or R_{sub}, and parasitic resistors 70 (Rₛ₁) and 72 (Rₛ₂) formed between parasitic transistors 62, 64. A holding voltage, V_{H}, of SCR 60 refers to a voltage drop across an anode 76 and a cathode 78 of SCR 60. Control circuit 74 exhibits a resistance of R′ in the circuit. By incorporating control circuit 74 with a resistance of R′ in parallel with the substrate resistor R_{sub}, V_{H} is expressed as follows:

V_{H}≅V_{cep}+V_{ben}×[1+Rₛ₂/(R_{sub}R′)]

wherein V_{cep} is the voltage across a collector (not numbered) and an emitter (not numbered) of PNP transistor 62, and V_{ben} is the voltage across a base (not numbered) and an emitter (not numbered) of NPN transistor 64. Therefore, V_{H} is raised when R′ is much smaller than R_{sub}, and is lowered when R′ is much greater than R_{sub}.

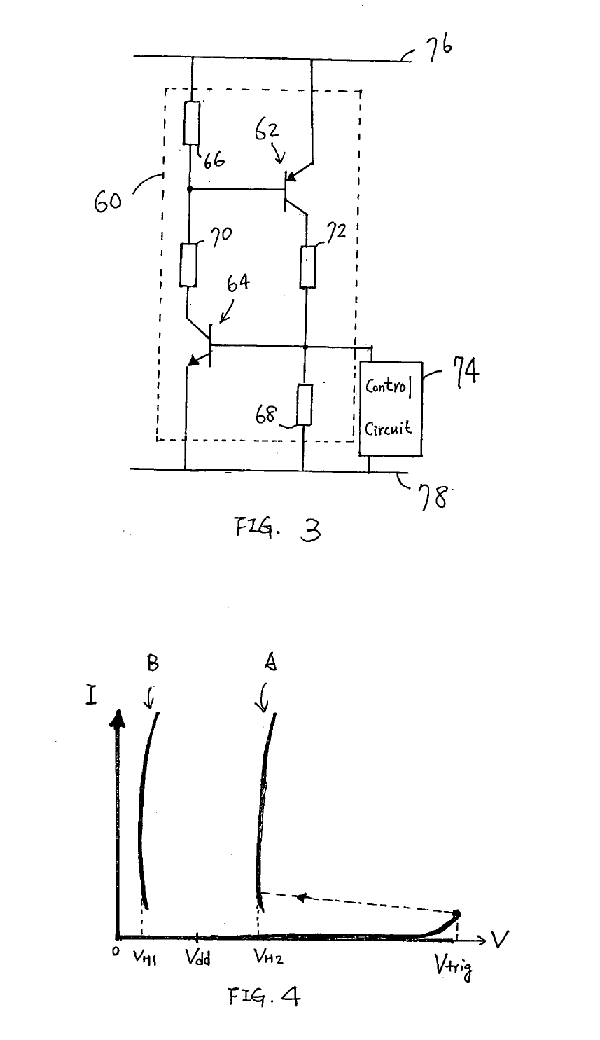

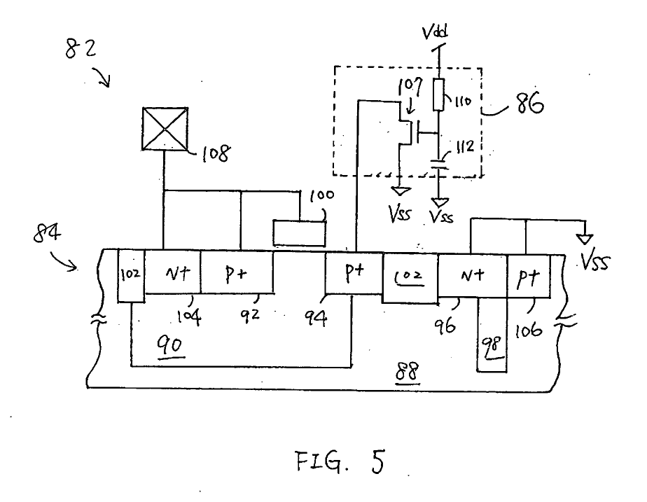

FIG. 4 is an I-V curve of SCR 60 shown in FIG. 3. SCR 60 has a holding voltage V_{H} and a trigger voltage V_{trig}. Referring to FIG. 4, V_{H} is dynamically adjustable between V_{H1} and V_{H2}. In the case that R′ is smaller than R_{sub}, SCR 60 has an I-V curve shown as curve A. In the case that R′ is greater than R_{sub}, SCR 60 has an I-V curve shown as curve B. That is, by changing the value of R′ coupled in parallel with the substrate resistor RSub, holding voltage V_{H} of SCR 60 is raised to V_{H2}, which is greater than the power supply voltage Vdd, or lowered to V_{H1}, which is smaller than Vdd. In one embodiment, V_{H1} is approximately equal to V_{H}. In another embodiment, V_{H1} is approximately 1 volt.

FIG. 5 shows a cross-sectional view of a layout of an ESD protection circuit 82 consistent with one embodiment of the present invention. Referring to FIG. 5, ESD protection circuit 82 includes an SCR 84 and a control circuit 86. SCR 84 includes a p-type substrate 88, an n-well 90, a first p-type diffused region 92 formed in n-well 90, a second p-type diffused region 94 partially formed in n-well 90, and a first n-type diffused region 96 partially formed in a different n-well 98. First p-type diffused region 92, n-well 90 and p-type substrate 88 serve as an emitter, a base and a collector respectively of a parasitic PNP bipolar transistor (not numbered). N-well 90, p-type substrate 88 and first n-type diffused region 96 serve as a collector, a base and an emitter respectively of a parasitic NPN bipolar transistor (not numbered). SCR 84 also includes a gate 100 disposed above a channel (not numbered) formed between first and second p-type diffused regions 92, 94. Field oxides 102 are used to provide electrical insulation. First p-type region 92, gate 100 and a second n-type region 104 are coupled to a contact pad 108, for example, an input/output (“I/O”) pad. First n-type region 96 and a third p-type region 106 are coupled to ground or a reference voltage, for example, Vss.

Control circuit 86 includes an NMOS transistor 107, a resistor 110 and a capacitor 112. NMOS transistor 107 includes a drain (not numbered) coupled to second p-type diffused region 94 of SCR 84. Resistor 110 includes one end (not numbered) coupled to capacitor 112 and the gate (not numbered) of NMOS transistor 107, and the other end (not numbered) coupled to power supply voltage Vdd. Capacitor 112 includes one end (not numbered) coupled to resistor 110 and the gate of NMOS transistor 107, and the other end (not numbered) coupled to Vss. In ESD protection circuit 82, control circuit 86 exhibits a smaller resistance than a substrate resistance of SCR 84 as NMOS transistor 107 turns on, and a greater resistance than the substrate resistance of SCR 84 as NMOS transistor 107 turns off.

An RC circuitry formed by resistor 110 and capacitor 112 provides a high level signal to the gate of NMOS transistor 107 to turn on NMOS transistor 107. As a result, control circuit 86 exhibits a smaller resistance than the substrate resistance of SCR 84. The holding voltage of SCR 84 is raised to a value above Vdd so that SCR 84 is kept from latching-up.

During an ESD event, the RC circuitry provides a low level signal to the gate of NMOS transistor 107 to turn off NMOS transistor 107. As a result, control circuit 86 exhibits a greater resistance than the substrate resistance of SCR 84. The holding voltage of SCR 84 is lowered to a value less than Vdd, one exemplary value being approximately 1 volt, to keep SCR 84 in the latch-up state to discharge an ESD current. To ensure that the RC circuitry maintains the gate of NMOS transistor 107 at a low voltage level during an ESD event, the RC circuitry is made to have an RC time delay of approximately 300 naroseconds (ns) to 500 ns, longer than a typical ESD pulse of 150 ns to 300 ns.

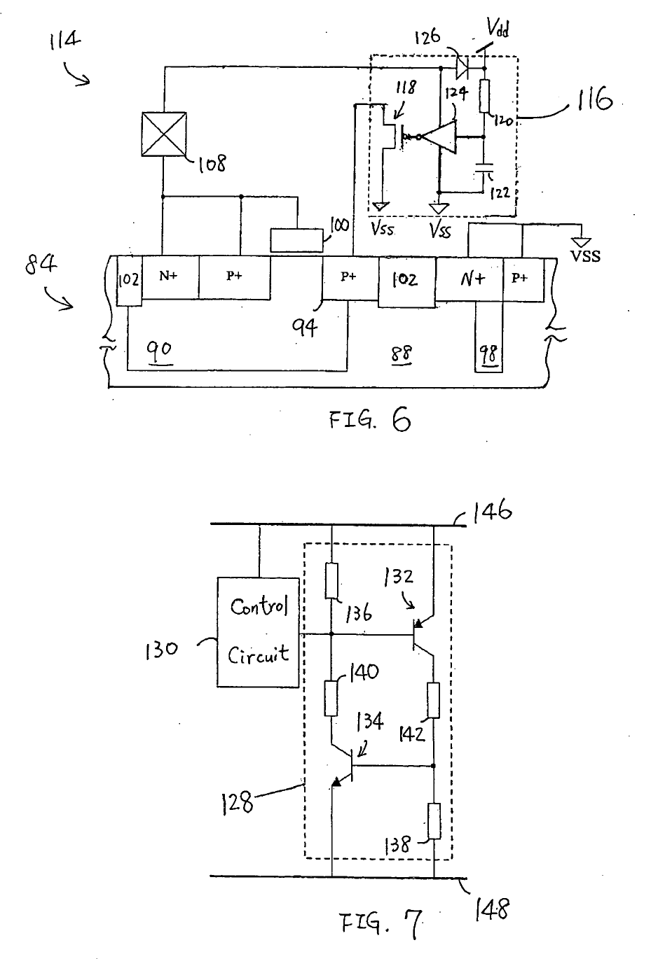

FIG. 6 shows another ESD protection circuit 114 consistent with one embodiment of the present invention. Referring to FIG. 6, ESD protection circuit 114 includes SCR 84 and a control circuit 116. Control circuit 116 includes a PMOS transistor 118, an inverter 124, a diode 126, a resistor 120 and a capacitor 122. PMOS transistor 118 includes a source (not numbered) coupled to second p-type diffused region 94 of SCR 84. Inverter 124 includes an output (not numbered) coupled to the gate (not numbered) of PMOS transistor 118. Resistor 110 includes one end (not numbered) coupled to capacitor 122 and an input (not numbered) of inverter 124, and the other end (not numbered) coupled to Vdd. Capacitor 122 includes one end (not numbered) coupled to resistor 120 and the input of inverter 124, and the other end (not numbered) coupled to Vss. In ESD protection circuit 114, control circuit 116 exhibits a smaller resistance than the substrate resistance of SCR 84 as PMOS transistor 118 turns on, and a greater resistance than the substrate resistance of SCR 84 as PMOS transistor 118 turns off.

An RC circuitry formed by resistor 120 and capacitor 122 provides through inverter 124 a low level signal to the gate of PMOS transistor 118 to turn on PMOS transistor 118. As a result, control circuit 116 exhibits a smaller resistance than the substrate resistance of SCR 84. The holding voltage of SCR 84 is raised to a value above Vdd so that SCR 84 is kept from latching-up.

During an ESD event, due to time delay, the RC circuitry maintains the input of inverter 124 at a low voltage level. Meanwhile, a part of ESD voltage from contact pad 108 biases inverter 124 so that inverter 124 outputs a high voltage level to the gate of PMOS 118 to turn off PMOS transistor 118. As a result, control circuit 116 exhibits a greater resistance than the substrate resistance of SCR 84. The holding voltage of SCR 84 is lowered to a value less than Vdd, one exemplary value being approximately 1 volt, to keep SCR 84 in the latch-up state to discharge an ESD current.

FIG. 7 shows another circuit diagram of an SCR 128 and a control circuit 130 in accordance with one embodiment of the present invention. Referring to FIG. 7, SCR 128 includes a parasitic PNP bipolar transistor 132, a parasitic NPN bipolar transistor 134, an n-well resistor 136 or RNW, a substrate resistor 138, and parasitic resistors 140 (Rₛ₃) and 142 (Rₛ₄) formed between parasitic transistors 132, 134. A holding voltage, Vₕ, of SCR 128 is a voltage drop across an anode 146 and a cathode 148 of SCR 128. Control circuit 130 exhibits a resistance of R″ in the circuit. By incorporating control circuit 136 with a resistance of R″ in parallel with n-well resistor 136 or R_{NW}, the holding voltage Vₕ of SCR 128 is expressed as follows:

Vₕ≅V_{cen}+V_{bep}×[1+Rₛ₃/(R_{NW}//R″)]

wherein V_{cen} is the voltage across a collector (not numbered) and an emitter (not numbered) of NPN transistor 134, Rₛ₃ is a parasitic resistor formed between bipolar transistors 132, 134, and V_{bep} is the voltage across a base (not numbered) and an emitter (not numbered) of PNP transistor 132. Therefore, Vₕ is raised when R″ is smaller than R_{NW}, and is lowered when R″ is greater than R_{NW}. The I-V curve of the circuit shown in FIG. 7 is similar to that shown in FIG. 4 and is not discussed.

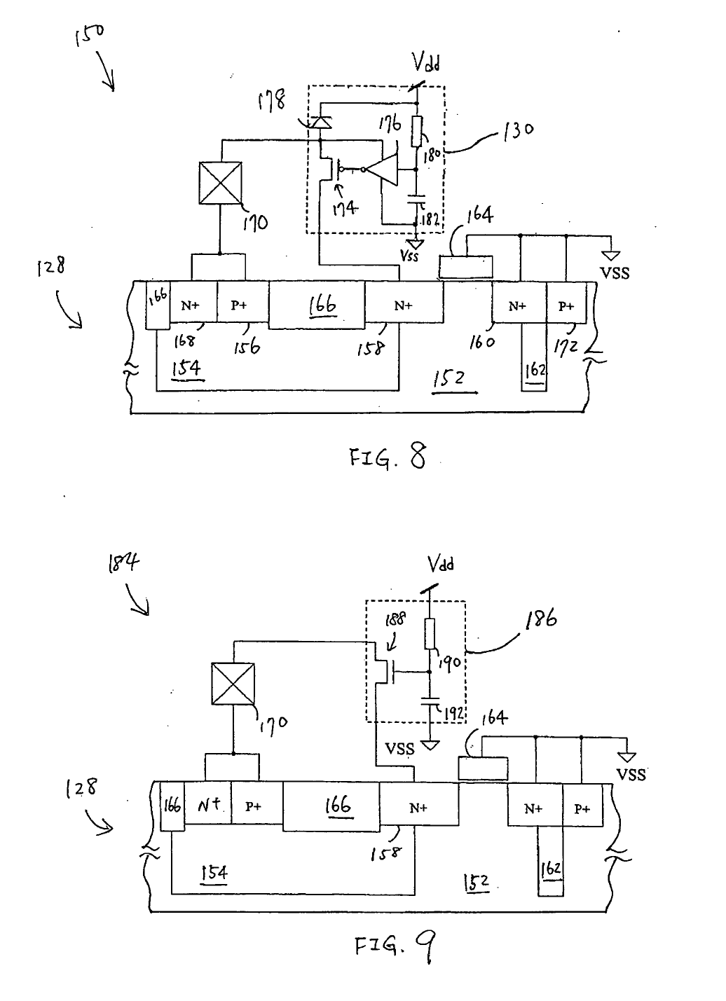

FIG. 8 shows an ESD protection circuit 150 consistent with one embodiment of the present invention. Referring to FIG. 8, ESD protection circuit 150 includes SCR 128 and control circuit 130. SCR 128 includes a p-type substrate 152, an n-well 154, a first p-type diffused region 156 formed in n-well 154, a first n-type diffused region 158 partially formed in n-well 154, and a second n-type diffused region 160 partially formed in a different n-well 162. First p-type diffused region 156, n-well 154 and p-type substrate 152 serve as an emitter, a base and a collector respectively of a parasitic PNP bipolar transistor (not numbered). N-well 154, p-type substrate 152 and second n-type diffused region 160 serve as a collector, a base and an emitter respectively of a parasitic NPN bipolar transistor (not numbered). SCR 128 also includes a gate 164 disposed above a channel (not numbered) formed between first and second n-type diffused regions 158, 160. Field oxides 166 are used to provide electrical insulation. First p-type region 156 and a third n-type region 168 are coupled to a contact pad 170. Second n-type region 160 and a second p-type region 172 are coupled to Vss.

Control circuit 130 includes a PMOS transistor 174, an inverter 176, a diode 178, a resistor 180 and a capacitor 182. PMOS transistor 174 includes a drain (not numbered) coupled to first n-type diffused region 158 of SCR 128. Inverter 176 includes an input (not numbered) coupled to the gate (not numbered) of PMOS transistor 174. Resistor 180 includes one end (not numbered) coupled to capacitor 182 and an input (not numbered) of inverter 176, and the other end (not numbered) coupled to diode 178 and Vdd. Capacitor 182 includes one end (not numbered) coupled to resistor 180 and the input of inverter 176, and the other end (not numbered) coupled to Vss. In ESD protection circuit 150, control circuit 130 exhibits a smaller resistance than the n-well resistance of SCR 128 as PMOS transistor 174 turns on, and a greater resistance than the n-well resistance of SCR 128 as PMOS transistor 174 turns off.

An RC circuitry formed by resistor 180 and capacitor 182 provides through inverter 176 a low level signal to the gate of PMOS transistor 174 to turn on PMOS transistor 174. As a result, control circuit 130 exhibits a smaller resistance than the n-well resistance of SCR 128. The holding voltage of SCR 128 is raised to a value above Vdd so that SCR 128 is kept from latching-up

During an ESD event, due to time delay, the RC circuitry maintains the input of inverter 176 at a low voltage level. Meanwhile, a part of ESD voltage from contact pad 170 biases inverter 176 so that inverter 176 outputs a high voltage level to the gate of PMOS 174 to turn off PMOS transistor 174. As a result, control circuit 130 exhibits a greater resistance than the n-well resistance of SCR 128. The holding voltage of SCR 128 is lowered to a value less than Vdd, one exemplary value being approximately 1 volt, to keep SCR 128 in the latch-up state to discharge an ESD current.

FIG. 9 shows another ESD protection circuit 184 consistent with one embodiment of the present invention. Referring to FIG. 9, ESD protection circuit 184 includes SCR 128 and a control circuit 186. Control circuit 186 includes an NMOS transistor 188, a resistor 190 and a capacitor 192. NMOS transistor 188 includes a source (not numbered) coupled to first n-type diffused region 158 of SCR 128. Resistor 190 includes one end (not numbered) coupled to capacitor 192 and the gate (not numbered) of NMOS transistor 188, and the other end (not numbered) coupled to Vdd. Capacitor 192 includes one end (not numbered) coupled to resistor 190 and the gate of NMOS transistor 188, and the other end (not numbered) coupled to Vss. In ESD protection circuit 184, control circuit 186 exhibits a smaller resistance than the n-well resistance of SCR 128 as NMOS transistor 188 turns on, and a greater resistance than the n-well resistance of SCR 128 as NMOS transistor 188 turns off.

An RC circuitry formed by resistor 190 and capacitor 192 provides a high level signal to the gate of NMOS transistor 188 to turn on NMOS transistor 188. As a result, control circuit 186 exhibits a smaller resistance than the n-well resistance of SCR 128. The holding voltage of SCR 128 is raised to a value above Vdd so that SCR 128 is kept from latching-up.

During an ESD event, due to time delay, the RC circuitry maintains the gate of NMOS transistor 188 at a low voltage level to turn off NMOS transistor 188. As a result, control circuit 186 exhibits a greater resistance than the n-well resistance of SCR 128. The holding voltage of SCR 128 is lowered to a value less than Vdd, one exemplary value being approximately 1 volt, to keep SCR 128 in the latch-up to state.

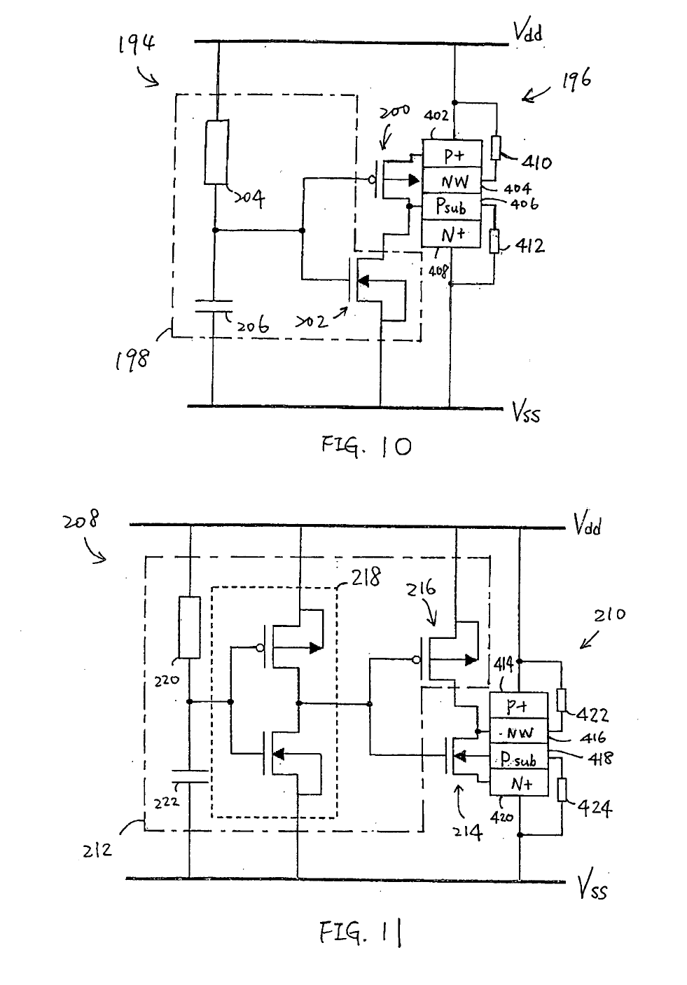

FIG. 10 shows an ESD protection circuit 194 for Vdd-to-Vss ESD protection according to the present invention. Referring to FIG. 10, ESD protection circuit 194 includes a PMOS-triggered SCR 196 and a control circuit 198. ESD protection circuit 194 has a similar circuit structure to circuit 82 shown in FIG. 5 except that an additional PMOS transistor 200 is included. PMOS-triggered SCR 196 includes an SCR (not numbered) and PMOS transistor 200. The SCR includes a p-type substrate 402 (Psub), an n-well 404 (NW), a p-type diffused region 406 (P+), an n-type diffused region 408 (N+), and parasitic resistors 410 (R_{NW}) and 412 (R_{sub}). PMOS transistor 200 includes a source (not numbered) coupled to P+ region 402, a drain (not numbered) coupled to p-type substrate 406, and a substrate coupled to the n-well 404 of the SCR. Control circuit 198 includes an NMOS transistor 202, a resistor 204 and a capacitor 206. Resistor 204 includes one end (not numbered) coupled to capacitor 206, the gate (not numbered) of PMOS transistor 200, and the gate (not numbered) of NMOS transistor 202, and the other end (not numbered) coupled to Vdd. Capacitor 206 includes one end (not numbered) coupled to resistor 204, the gate of PMOS transistor 200, and the gate of NMOS transistor 202, and the other end (not numbered) coupled to Vss. In ESD protection circuit 194, control circuit 198 exhibits a smaller resistance than the substrate resistance of PMOS-triggered SCR 196 as NMOS transistor 202 turns on, and a greater resistance than the substrate resistance of PMOS-triggered SCR 196 as NMOS transistor 202 turns off.

An RC circuitry formed by resistor 204 and capacitor 206 provides a high level signal to the gate of PMOS transistor 200 and the gate of NMOS transistor 202 to turn off PMOS transistor 200 and turn on NMOS transistor 202. As a result, control circuit 198 exhibits a smaller resistance than the substrate resistance of PMOS-triggered SCR 196. The holding voltage of PMOS-triggered SCR 196 is raised to a value above Vdd so that PMOS-triggered SCR 196 is kept from latching-up.

During an ESD event, for example, a positive ESD pulse occurring at Vdd line, due to time delay, the RC circuitry provides a low level signal to the gates of PMOS transistor 200 and NMOS transistor 202 to turn on PMOS transistor 200 and turn off NMOS transistor 202. As a result, control circuit 198 exhibits a greater resistance than the substrate resistance of PMOS-triggered SCR 196. The holding voltage of PMOS-triggered SCR 196 is lowered to a value less than Vdd, one exemplary value being approximately 1 volt, to keep PMOS-triggered SCR 196 in the latch-up state to discharge an ESD current.

FIG. 11 shows another ESD protection circuit 208 for Vdd-to-Vss ESD protection according to the present invention. Referring to FIG. 11, ESD protection circuit 208 includes an NMOS-triggered SCR 210 and a control circuit 212. ESD protection circuit 208 has a similar circuit structure to circuit 150 shown in FIG. 8 except that an additional NMOS transistor 214 is included. NMOS-triggered SCR 210 includes an SCR (not numbered) and NMOS transistor 214. The SCR includes a p-type diffused region 414 (P+), an n-well 416 (NW), a p-type substrate 418 (P_{sub}), an n-type diffused region 420 (N+), and parasitic resistors 422 (R_{NW}) and 424 (R_{sub}). NMOS transistor 214 includes a drain (not numbered) coupled to N+ region 420, a source (not numbered) coupled to n-well 416, and a substrate (not numbered) coupled to p-type substrate 418 of the SCR. Control circuit 212 includes a PMOS transistor 216, an inverter 218, a resistor 220 and a capacitor 222. Inverter 218 provides an output to the gate (not numbered) of NMOS transistor 214 and the gate (not numbered) of PMOS transistor 216. Resistor 220 is coupled at one end to capacitor 222 and the input (not numbered) of inverter 218, and at the other end to Vdd. Capacitor 222 includes one end (not numbered) coupled to resistor 220 and the input of inverter 218, and the other end coupled to Vss. In ESD protection circuit 208, control circuit 212 exhibits a smaller resistance than the n-well resistance of NMOS-triggered SCR 210 as PMOS transistor 216 turns on, and a greater resistance than the n-well resistance of NMOS-triggered SCR 210 as PMOS transistor 216 turns off.

An RC circuitry formed by resistor 220 and capacitor 222 provides through inverter 218 a low level signal to the gate of NMOS transistor 214 and the gate of PMOS transistor 216 to turn off NMOS transistor 214 and turn on PMOS transistor 216. As a result, control circuit 212 exhibits a smaller resistance than the n-well resistance of NMOS-triggered SCR 210. The holding voltage of NMOS-triggered SCR 210 is raised to a value above Vdd so that NMOS-triggered SCR 210 is kept from latching-up.

During an ESD event, for example, a positive ESD pulse occurring at Vdd line, due to time delay, the RC circuitry provides, through inverter 218, a high level signal to the gates of NMOS transistor 214 and PMOS transistor 216 to turn on NMOS transistor 214 and turn off PMOS transistor 216. As a result, control circuit 212 exhibits a greater resistance than the n-well resistance of NMOS-triggered SCR 210. The holding voltage of NMOS-triggered SCR 210 is lowered to a value less than Vdd, one exemplary value being approximately 1 volt, to keep NMOS-triggered SCR 210 in the latch-up state to discharge an ESD current.

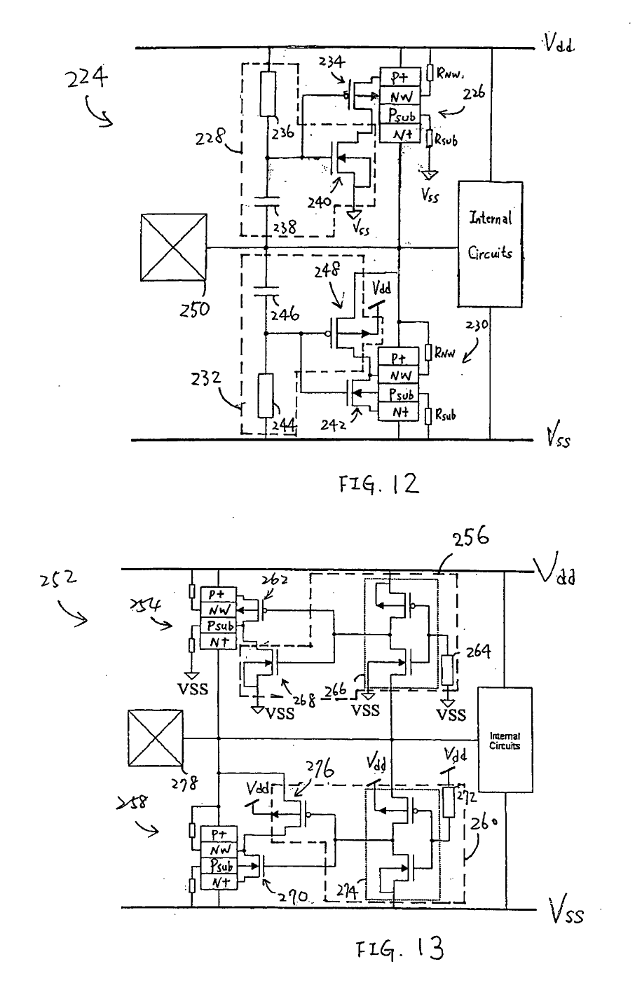

FIG. 12 shows an input-stage ESD protection circuit 224 in accordance with one embodiment of the present invention. Referring to FIG. 12, ESD protection circuit 224 includes a PMOS-triggered SCR 226, a first control circuit 228, an NMOS-triggered SCR 230 and a second control circuit 232. PMOS-triggered SCR 226 includes an SCR (not numbered) and a PMOS transistor 234. First control circuit 228 includes a resistor 236, a capacitor 238 and an NMOS transistor 240. NMOS-triggered SCR 230 includes a different SCR (not numbered) and an NMOS transistor 242. Second control circuit 232 includes a resistor 244, a capacitor 246 and a PMOS transistor 248.

For PMOS-triggered SCR 226, PMOS transistor 234 is turned off and NMOS transistor 240 is turned on. Since NMOS transistor 240 of first control circuit 228 is turned on, the holding voltage of PMOS-triggered SCR 226 is raised to a value above Vdd so that PMOS-triggered SCR 226 is kept from latching-up.

In addition, for NMOS-triggered SCR 230, NMOS transistor 242 is turned off and PMOS transistor 248 is turned on. Since PMOS transistor 248 of second control circuit 232 is turned on, the holding voltage of NMOS-triggered SCR 230 is raised to a value above Vdd so that NMOS-triggered SCR 230 is also kept from latching-up during normal operations.

During a Positive-to-Vss (“PS”) mode ESD event, capacitor 246 couples a part of the ESD voltage from a contact pad 250 to the gates of NMOS transistor 242 and PMOS transistor 248. Therefore, the gates of NMOS transistor 242 and PMOS transistor 248 are positively biased to turn on NMOS transistor 242 and turn off PMOS transistor 248. Since PMOS transistor 248 of second control circuit 232 is turned off, the holding voltage of NMOS-triggered SCR 230 is lowered to a value less than Vdd, one exemplary value being approximately 1 volt, so that NMOS-triggered SCR 230 is kept in the latch-up state. In addition, since NMOS transistor 242 is turned on, NMOS-triggered SCR 230 is able to be turned on quickly to discharge an ESD current. The positive ESD stress occurring at contact pad 250 is clamped at approximately 1 volt by ESD protection circuit 224.

During a Negative-to-Vdd (“ND”) mode ESD event, capacitor 238 couples a part of the ESD voltage from a contact pad 250 to the gates of NMOS transistor 240 and PMOS transistor 234. Therefore, the gates of NMOS transistor 240 and PMOS transistor 234 are negatively biased to turn off NMOS transistor 240 and turn on PMOS transistor 234. Since NMOS transistor 240 of first control circuit 228 is turned off, the holding voltage of PMOS-triggered SCR 226 is lowered to a value less than Vdd, one exemplary value being approximately −1 volt, so that PMOS-triggered SCR 226 is kept in the latch-up state. Meanwhile, in addition, since PMOS transistor 234 is turned on, PMOS-triggered SCR 226 is able to be turned on quickly to discharge an ESD current. The negative ESD stress occurring at contact pad 250 is clamped at approximately −1 volt by ESD protection circuit 224.

FIG. 13 shows another input-stage ESD protection circuit 252 in accordance with one embodiment of the present invention. Referring to FIG. 13, ESD protection circuit 252 includes a PMOS-triggered SCR 254, a first control circuit 256, an NMOS-triggered SCR 258, and a second control circuit 260. PMOS-triggered SCR 254 includes an SCR (not numbered) and a PMOS transistor 262. First control circuit 256 includes a resistor 264, an inverter 266 and an NMOS transistor 268. NMOS-triggered SCR 258 includes a different SCR (not numbered) and an NMOS transistor 270. Second control circuit 260 includes a resistor 272, an inverter 274, and a PMOS transistor 276.

For PMOS-triggered SCR 254, inverter 266 provides a high voltage level to the gate of PMOS transistor 262 and the gate of NMOS transistor 268 to turn off PMOS transistor 262 and turn on NMOS transistor 268. Since NMOS transistor 268 of first control circuit 256 is turned on, the holding voltage of PMOS-triggered SCR 254 is raised to a value above Vdd so that PMOS-triggered SCR 254 is kept from latching-up.

In addition, for NMOS-triggered SCR 258, inverter 274 provides a low voltage level to the gate of NMOS transistor 270 and the gate of PMOS transistor 276 to turn off NMOS transistor 270 and turn on PMOS transistor 276. Since PMOS transistor 276 of second control circuit 260 is turned on, the holding voltage of NMOS-triggered SCR 258 is raised to a value above Vdd so that NMOS-triggered SCR 258 is kept from latching-up.

During a PS-mode ESD event, inverter 274, biased by a part of the ESD voltage from a contact pad 278, provides a high voltage level to the gates of NMOS transistor 270 and PMOS transistor 276. Therefore, the gates of NMOS transistor 270 and PMOS transistor 276 are positively biased to turn on NMOS transistor 270 and turn off PMOS transistor 276. Since PMOS transistor 276 of second control circuit 260 is turned off, the holding voltage of NMOS-triggered SCR 258 is lowered to a value less than Vdd, one exemplary value being approximately 1 volt, so that NMOS-triggered SCR 258 is kept in the latch-up state. In addition, since NMOS transistor 270 is turned on, NMOS-triggered SCR 258 is able to be turned on quickly to discharge an ESD current. The positive ESD stress occurring at contact pad 278 is clamped at approximately 1 volt by ESD protection circuit 252.

During an ND-mode ESD event, inverter 266, biased by a part of ESD voltage from contact pad 278, provides a low voltage level to the gates of NMOS transistor 268 and PMOS transistor 262. Therefore, the gates of NMOS transistor 268 and PMOS transistor 262 are negatively biased to turn off NMOS transistor 268 and turn on PMOS transistor 262. Since NMOS transistor 268 of first control circuit 256 is turned off, the holding voltage of PMOS-triggered SCR 254 is lowered to a value less than Vdd, one exemplary value being approximately −1 volt, so that PMOS-triggered SCR 254 is kept in the latch-up state. Furthermore, since PMOS transistor 262 is turned on, PMOS-triggered SCR 254 is able to be turned on quickly to discharge an ESD current. The negative ESD stress occurring at contact pad 278 is clamped at approximately −1 volt by ESD protection circuit 252.

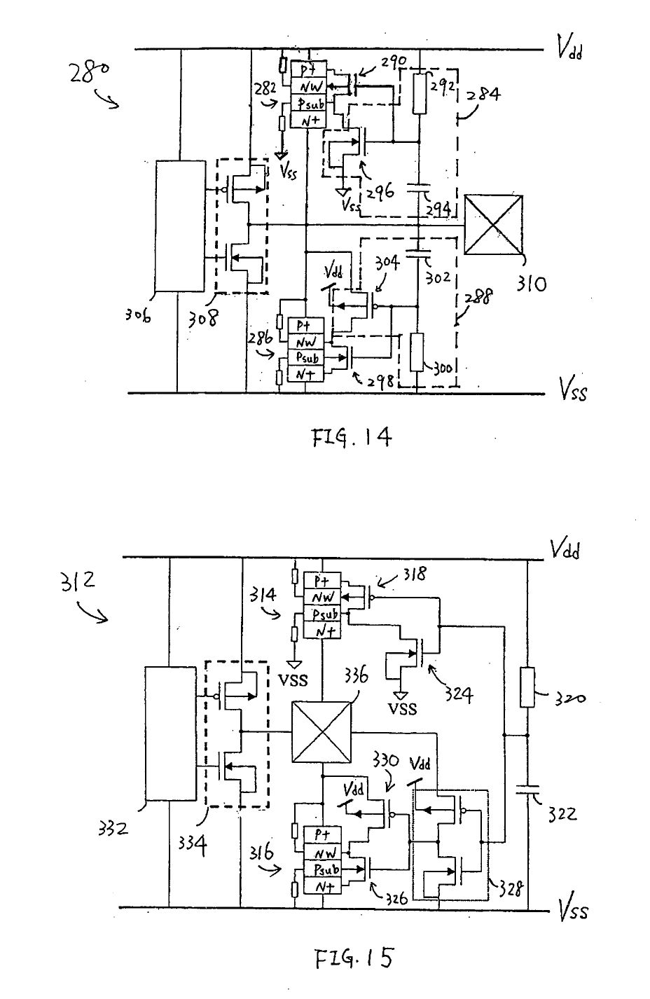

FIG. 14 shows an output-stage ESD protection circuit 280 in accordance with one embodiment of the present invention. Referring to FIG. 14, ESD protection circuit 280 includes a PMOS-triggered SCR 282, a first control circuit 284, an NMOS-triggered SCR 286, and a second control circuit 288. PMOS-triggered SCR 282 includes an SCR (not numbered) and a PMOS transistor 290. First control circuit 284 includes a resistor 292, a capacitor 294, and an NMOS transistor 296. NMOS-triggered SCR 286 includes a different SCR (not numbered) and an NMOS transistor 298. Second control circuit 288 includes a resistor 300, a capacitor 302 and a PMOS transistor 304. A first buffer 306 and a second buffer 308 are provided to buffer signals sent from internal circuits (not shown) to a contact pad 310.

For PMOS-triggered SCR 282, the gate of PMOS transistor 290 and the gate of NMOS transistor 296 are coupled to Vdd through resistor 292 to turn off PMOS transistor 290 and turn on NMOS transistor 296. Since NMOS transistor 296 of first control circuit 284 is turned on, the holding voltage of PMOS-triggered SCR 282 is raised to a value above Vdd so that PMOS-triggered SCR 282 is kept from latching-up.

For NMOS-triggered SCR 286, the gate of NMOS transistor 298 and the gate of PMOS transistor 304 are coupled to Vss through resistor 300 to turn off NMOS transistor 298 and turn on PMOS transistor 304. Since PMOS transistor 304 of second control circuit 288 is turned on, the holding voltage of NMOS-triggered SCR 286 is raised to a value above Vdd so that NMOS-triggered SCR 286 is kept from latching-up.

During a PS-mode ESD event, capacitor 302 couples a part of the ESD voltage from contact pad 310 to the gates of NMOS transistor 298 and PMOS transistor 304. Therefore, the gates of NMOS transistor 298 and PMOS transistor 304 are positively biased to turn on NMOS transistor 298 and turn off PMOS transistor 304. Since PMOS transistor 304 of second control circuit 288 is turned off, the holding voltage of NMOS-triggered SCR 286 is lowered to a value less than Vdd, one exemplary value being approximately 1 volt, so that NMOS-triggered SCR 286 is kept in the latch-up state. In addition, since NMOS transistor 298 is turned on, NMOS-triggered SCR 286 is able to be turned on quickly to discharge an ESD current. The positive ESD stress occurring at contact pad 310 is clamped at approximately 1 volt by ESD protection circuit 280.

During an ND-mode ESD event, capacitor 294 couples a part of ESD voltage from contact pad 310 to the gates of NMOS transistor 296 and PMOS transistor 290. Therefore, the gates of NMOS transistor 296 and PMOS transistor 290 are negatively biased to turn off NMOS transistor 296 and turn on PMOS transistor 290. Since NMOS transistor 296 of first control circuit 284 is turned off, the holding voltage of PMOS-triggered SCR 282 is lowered to a value less than Vdd, one exemplary value being approximately −1 volt, so that PMOS-triggered SCR 282 is kept in the latch-up state. Furthermore, since PMOS transistor 290 is turned on, PMOS-triggered SCR 282 is able to be turned on quickly to discharge an ESD current. The negative ESD stress occurring at contact pad 310 is clamped at approximately −1 volt by ESD protection circuit 280.

FIG. 15 shows another output-stage ESD protection circuit 312 in accordance with one embodiment of the present invention. Referring to FIG. 15, ESD protection circuit 312 includes a PMOS-triggered SCR 314, a first control circuit (not numbered), an NMOS-triggered SCR 316 and a second control circuit (not numbered). PMOS-triggered SCR 314 includes an SCR (not numbered) and a PMOS transistor 318. The first control circuit includes a resistor 320, a capacitor 322 and an NMOS transistor 324. NMOS-triggered SCR 316 includes a different SCR (not numbered) and an NMOS transistor 326. The second control circuit includes resistor 320, capacitor 322, an inverter 328 and a PMOS transistor 330. A first buffer 332 and a second buffer 334 are provided to buffer signals sent from internal circuits to a contact pad 336.

For PMOS-triggered SCR 314, an RC circuitry formed by resistor 320 and capacitor 322 provides a high voltage level to the gate of PMOS transistor 318 and the gate of NMOS transistor 324 to turn off PMOS transistor 318 and turn on NMOS transistor 324. Since NMOS transistor 324 of the first control circuit is turned on, the holding voltage of PMOS-triggered SCR 314 is raised to a value above Vdd so that PMOS-triggered SCR 314 is kept from latching-up.

For NMOS-triggered SCR 258, the RC circuitry provides through inverter 328 a low voltage level to the gate of NMOS transistor 326 and the gate of PMOS transistor 330 to turn off NMOS transistor 326 and turn on PMOS transistor 330. Since PMOS transistor 330 of the second control circuit is turned on, the holding voltage of NMOS-triggered SCR 316 is raised to a value above Vdd so that NMOS-triggered SCR 316 is kept from latching-up during normal operations.

During a PS-mode ESD event, a part of ESD current flows to Vdd line through a parasitic diode (not shown) formed by a p-type diffused region (not shown) and an n-well (not shown) in a PMOS transistor (not numbered) of second buffer 334. Due to time delay, the RC circuitry provides a high voltage level through inverter 328 to the gates of NMOS transistor 326 and PMOS transistor 330 to turn on NMOS transistor 326 and turn off PMOS transistor 330. Since PMOS transistor 330 of the second control circuit is turned off, the holding voltage of NMOS-triggered SCR 316 is lowered to a value less than Vdd, one exemplary value being approximately 1 volt, so that NMOS-triggered SCR 316 is kept in the latch-up state. In addition, since NMOS transistor 326 is turned on, NMOS-triggered SCR 316 is able to be turned on quickly to discharge an ESD current. The positive ESD stress occurring at contact pad 336 is clamped at approximately 1 volt by ESD protection circuit 312.

During an ND-mode ESD event, a part of ESD current flows to Vss line through a parasitic diode (not shown) formed by an n-type diffused region (not shown) and a p-well (not shown) in an NMOS transistor (not numbered) of second buffer 334. Since capacitor 322 couples a part of ESD voltage from contact pad 336, the RC circuitry provides a low voltage level to the gates of NMOS transistor 324 and PMOS transistor 318 to turn off NMOS transistor 324 and turn on PMOS transistor 318. Since NMOS transistor 324 of the first control circuit is turned off, the holding voltage of PMOS-triggered SCR 314 is lowered to a value less than Vdd, one exemplary value being approximately −1 volt, so that PMOS-triggered SCR 314 is kept in the latch-up state. Furthermore, since PMOS transistor 318 is turned on, PMOS-triggered SCR 314 is able to be turned on quickly to discharge an ESD current. The negative ESD stress occurring at contact pad 336 is clamped at approximately −1 volt by ESD protection circuit 312.

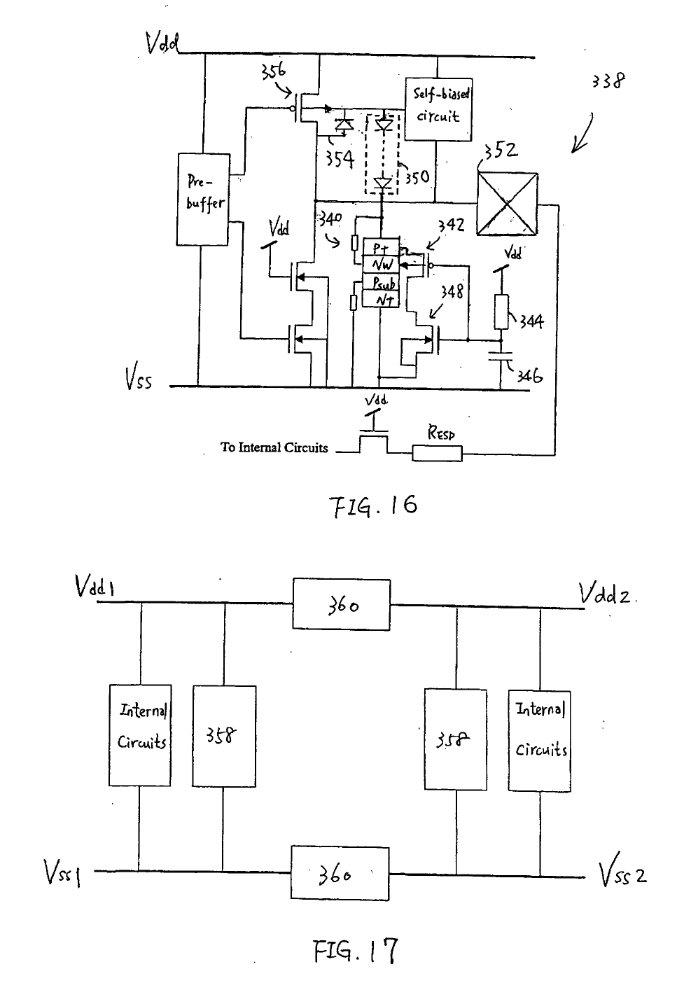

FIG. 16 shows an ESD protection circuit 338 in a mixed-voltage I/O stage in accordance with one embodiment of the present invention. Referring to FIG. 16, ESD protection circuit 338 includes a PMOS-triggered SCR 340 and a control circuit (not numbered). PMOS-triggered SCR 340 includes an SCR (not numbered) and a PMOS transistor 342. The control circuit includes a resistor 344, a capacitor 346 and an NMOS transistor 348.

An RC circuitry formed by resistor 344 and capacitor 346 provides a high voltage level to the gate of NMOS transistor 348 and the gate of PMOS transistor 342 to turn on NMOS transistor 348 and turn off PMOS transistor 342. Since NMOS transistor 348 of the control circuit is turned on, the holding voltage of PMOS-triggered SCR 340 is raised to a value above Vdd so that PMOS-triggered SCR 340 is kept from latching-up. During normal operations, PMOS transistor 342 may be inadvertently turned on due to a positive source-to-gate voltage, resulting in current leakage. In one embodiment, to prevent PMOS transistor 342 from current leakage during normal operations, a diode string 350 is coupled to PMOS-triggered SCR 340.

During an ESD event, for example, a positive ESD pulse occurring at a contact pad 352, an ESD current flows through a parasitic diode 354 formed by a drain (not numbered) and a substrate (not numbered) of a PMOS transistor 356 to diode string 350 and PMOS-triggered SCR 340. Due to time delay, the RC circuitry provides a low voltage level to the gates of NMOS transistor 348 and PMOS transistor 342 to turn off NMOS transistor 348 and turn on PMOS transistor 342. Since NMOS transistor 348 is turned off, the holding voltage of PMOS-triggered SCR 342 is lowered to a value below Vdd so that PMOS-triggered SCR 340 is kept in the latch-up state. In addition, since PMOS transistor 342 is turned on, PMOS-triggered SCR 340 is able to be quickly turned on to discharge the ESD current. ESD protection circuit 338 clamps the positive ESD pulse at a voltage level lower than Vdd, depending on the number of diodes coupled in diode string 350.

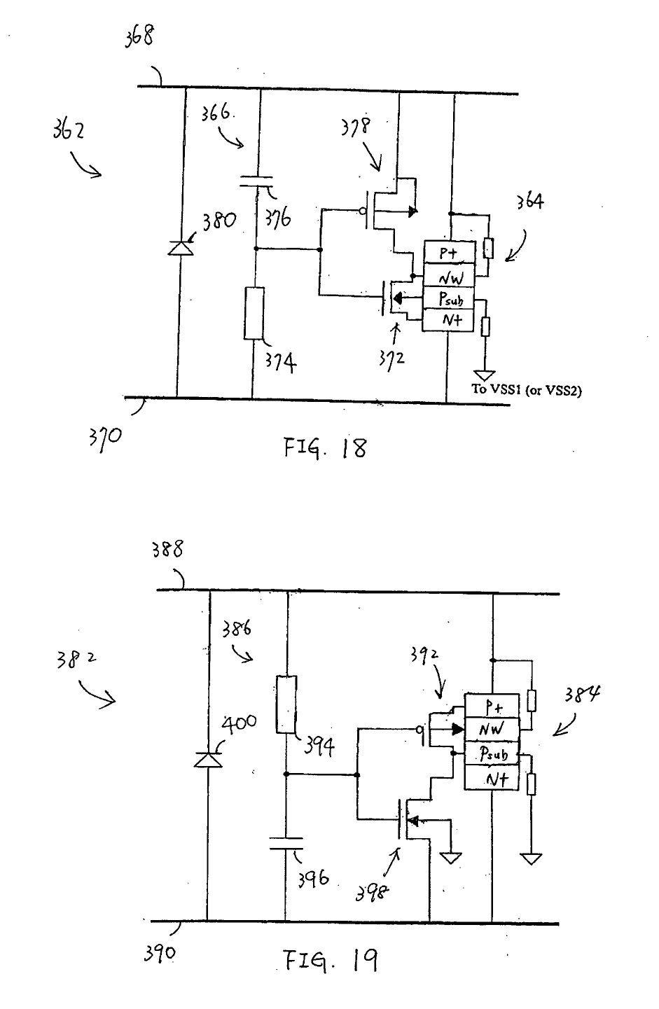

FIG. 17 is a schematic circuit diagram showing ESD protection for mixed-voltage power supplies in accordance with one embodiment of the present invention. Referring to FIG. 17, in addition to ESD clamps 358 coupled between a high voltage line and a low voltage, which have been discussed in the previous embodiments, ESD clamps 360 coupled between two high voltage lines Vdd1, Vdd2 or two low voltage lines Vss1, Vss2 are provided.

FIG. 18 shows a circuit 362 for mixed-voltage power supplies ESD protection using an NMOS-triggered SCR 364 in accordance with one embodiment of the present invention. Referring to FIG. 18, ESD protection circuit 362 is coupled between a first voltage line 368 and a second voltage line 370. In one embodiment, first and second voltage lines 368, 370 are both high voltage lines, for example, Vdd1 and Vdd2 of different or equal voltage levels. In another embodiment, first and second voltage lines 368, 370 are both low voltage lines, for example, Vss1 and Vss2 of different or equal voltage levels. ESD protection circuit 362 includes NMOS-triggered SCR 364 and a control circuit 366. NMOS-triggered SCR 364 includes an SCR (not numbered) and an NMOS transistor 372. Control circuit 366 includes a resistor 374, a capacitor 376 and a PMOS transistor 378.

Supposing first voltage line 368 is greater than second voltage line 370 in power supply level, for example, Vdd1>Vdd2, during normal operations, an RC circuitry formed by resistor 374 and capacitor 376 provides a voltage level of Vdd2 to the gate of NMOS transistor 372 and the gate of PMOS transistor 378. At this point, PMOS transistor 378 is turned on because its source potential, i.e., Vdd1, is greater than its gate potential, Vdd2. Meanwhile, NMOS transistor 372 is turned off because its gate and source are of a same potential, Vdd2. Since PMOS transistor 378 of control circuit 366 is turned on, the holding voltage of NMOS-triggered SCR 364 is raised to a value above Vdd1 so that NMOS-triggered SCR 364 is kept form latching-up.

When a positive ESD pulse occurs at Vdd1 line 368, and Vdd2 line 370 is grounded, since capacitor 376 couples a part of ESD voltage, the RC circuitry provides a positive voltage to the gates of NMOS transistor 372 and PMOS transistor 378 to turn on NMOS transistor 372 and turn off PMOS transistor 378. Since PMOS transistor 378 of control circuit 366 is turned off, the holding voltage of NMOS-triggered SCR 364 is lowered to a value less than Vdd1, one exemplary value being approximately 1 volt, so that NMOS-triggered SCR 364 is kept in the latch-up state. In addition, since NMOS transistor 372 is turned on, NMOS-triggered SCR 364 is able to be quickly turned on to discharge an ESD current and clamp the positive ESD pulse at approximately 1 volt.

When a negative ESD pulse occurs at Vdd2 line 370 and Vdd1 line 368 is grounded, due to time delay, the RC circuitry provides a ground voltage to the gates of NMOS transistor 372 and PMOS transistor 378. At this point, PMOS transistor 378 is turned off because its source and gate are of a same potential, i.e., ground voltage. In addition, NMOS transistor 372 is turned on because its gate potential is greater than its source potential. Since PMOS transistor 378 of control circuit 366 is turned off, the holding voltage of NMOS-triggered SCR 364 is lowered to a value of approximately −1 volt so that NMOS-triggered SCR 364 is kept in the latch-up state. Meanwhile, in addition, since NMOS transistor 372 is turned on, NMOS-triggered SCR 364 is able to be quickly turned on to discharge an ESD current and clamp the negative ESD pulse at approximately −1 volt.

When a positive ESD pulse occurs at Vdd2 line 370 and Vdd1 line 368 is grounded, a diode 380 is forward biased to clamp the positive ESD pulse at a threshold voltage of diode 380.

When a negative ESD pulse occurs at Vdd1 line 368 and Vdd2 line 370 is grounded, diode 380 is forward biased to clamp the negative ESD pulse at the threshold voltage of diode 380.

FIG. 19 shows a circuit 382 for mixed-voltage power supplies ESD protection using a PMOS-triggered SCR 384 in accordance with one embodiment of the present invention. Referring to FIG. 19, ESD protection circuit 382 is coupled between a first voltage line 388 and a second voltage line 390. In one embodiment, first and second voltage lines 388, 390 are both high voltage lines, for example, Vdd1 and Vdd2 of different or equal voltage levels. In another embodiment, first and second voltage lines 388, 390 are both low voltage lines, for example, Vss1 and Vss2 of different or equal voltage levels. ESD protection circuit 382 includes PMOS-triggered SCR 384 and a control circuit 386. PMOS-triggered SCR 384 includes an SCR (not numbered) and a PMOS transistor 392. Control circuit 386 includes a resistor 394, a capacitor 396 and an NMOS transistor 398.

Supposing first voltage line 388 is greater than second voltage line 390 in power supply level, for example, Vdd1>Vdd2, during normal operations, an RC circuitry formed by resistor 394 and capacitor 396 provides a voltage level of Vdd1 to the gate of PMOS transistor 392 and the gate of NMOS transistor 398. At this point, NMOS transistor 398 is turned on because its gate potential, i.e., Vdd1, is greater than its source potential, Vdd2. In addition, PMOS transistor 392 is turned off because its gate and source are of a same potential, Vdd1. Since NMOS transistor 398 of control circuit 386 is turned on, the holding voltage of PMOS-triggered SCR 384 is raised to a value above Vdd1 so that PMOS-triggered SCR 384 is kept form latching-up.

When a positive ESD pulse occurs at Vdd1 line 388, and Vdd2 line 390 is grounded, due to time delay, the RC circuitry outputs a ground voltage to the gates of PMOS transistor 392 and NMOS transistor 398. At this point, NMOS transistor 398 is turned off because its source and gate are of a same potential, i.e., ground voltage. In addition, PMOS transistor 392 is turned on because its source potential is greater than its gate potential. Since NMOS transistor 398 of control circuit 386 is turned off, the holding voltage of PMOS-triggered SCR 384 is lowered to a value of approximately 1 volt so that PMOS-triggered SCR 384 is kept in the latch-up state. Meanwhile, in addition, since PMOS transistor 392 is turned on, PMOS-triggered SCR 384 is able to be quickly turned on to discharge an ESD current and clamp the positive ESD pulse at approximately 1 volt.

When a negative ESD pulse occurs at Vdd2 line 390 and Vdd1 line 388 is grounded, since capacitor 396 couples a part of ESD voltage, the RC circuitry provides a negative voltage to the gates of PMOS transistor 392 and NMOS transistor 398 to turn on PMOS transistor 392 and turn off NMOS transistor 398. Since NMOS transistor 398 of control circuit 386 is turned off, the holding voltage of PMOS-triggered SCR 384 is lowered to a value less than Vdd1, one exemplary value being approximately −1 volt, so that PMOS-triggered SCR 384 is kept in the latch-up state. Meanwhile, in addition, since PMOS transistor 392 is turned on, PMOS-triggered SCR 384 is able to be quickly turned on to discharge an ESD current and clamp the negative ESD pulse at approximately −1 volt.

When a positive ESD pulse occurs at Vdd2 line 390 and Vdd1 line 388 is grounded, a diode 400 is forward biased to clamp the positive ESD pulse at a threshold voltage of diode 400.

When a negative ESD pulse occurs at Vdd1 line 388 and Vdd2 line 390 is grounded, diode 400 is forward biased to clamp the negative ESD pulse at the threshold voltage of diode 400.

The present invention also provides a method for electrostatic discharge protection. The method comprises providing an SCR having a holding voltage, and controlling the holding voltage of the SCR to be above or below a power supply voltage Vdd. Specifically, the method of the present invention raising the holding voltage of the SCR to above Vdd during normal operations to keep the SCR from latching-up, and lowering the holding voltage of the SCR to below Vdd during an ESD event to keep the SCR in the latch-up state.

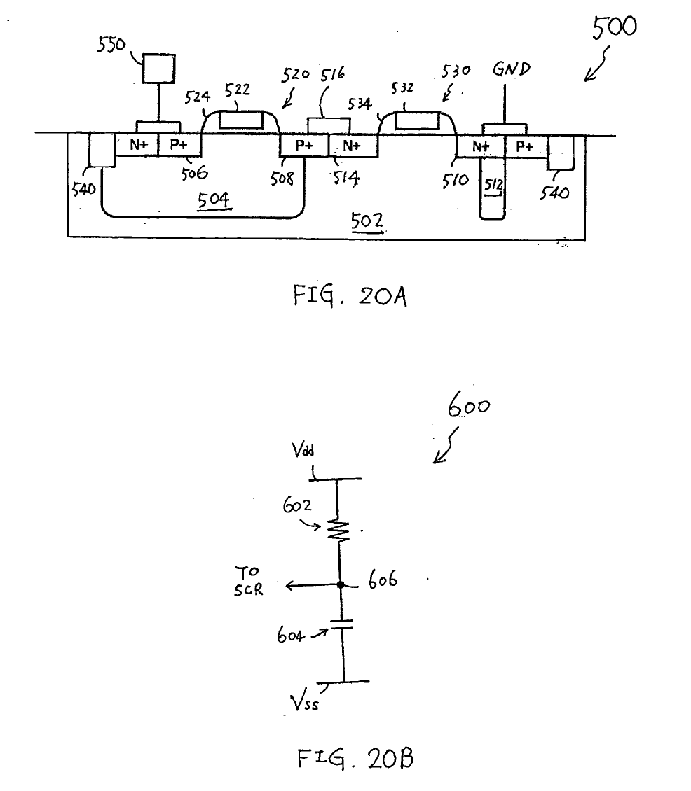

FIG. 20A shows a cross-sectional view of an SCR 500 in accordance with one embodiment of the present invention. SCR 500 has a similar structure to SCR 84 shown in FIG. 5 or SCR 128 shown in FIG. 9 except that NMOS transistor 107 of control circuit 86 shown in FIG. 5 or NMOS transistor 188 of control circuit 186 is embedded in SCR 500. Incorporation of an MOS transistor into an SCR that would otherwise be included in a control circuit may simplify an SCR layout, decrease SCR size and reduce the complexity of a control circuit.

Referring to FIG. 20A, SCR 500 includes a p-type substrate 502, an n-well 504, a first p-type diffused region 506 formed in n-well 504, a second p-type diffused region 508 partially formed in n-well 504, a first n-type diffused region 510 partially formed in a different n-well 512, and a second n-type diffused region 514 formed in p-type substrate 502. Second n-type diffused region 514 is connected to second p-type diffused region 508 by a metal or salicide layer 516. A p-type transistor 520 and an n-type transistor 530 are formed integrally with SCR 500. P-type transistor 520 includes a gate 522, a sidewall spacer 524 and a channel (not numbered) formed in n-well 504. First p-type diffused region 506 and second p-type diffused region 508 respectively serve as a source and a drain of p-type transistor 520. N-type transistor 530 includes a gate 532, a sidewall spacer 534 and a channel (not numbered) formed in p-type substrate 502. First n-type diffused region 510 and second n-type diffused region 514 respectively serve as a source and a drain of n-type transistor 530. P-type transistor 520 functions to facilitate the turn-on of SCR 500. N-type transistor 530 functions to control the holding voltage of SCR 500.

Field oxides 540 are used to provide electrical insulation. First p-type diffused region 506, which serves as an anode of SCR 500, is coupled to a contact pad 550. First n-type diffused region 510, which serves as a cathode of SCR 500, is coupled to a reference voltage or ground level (GND). In one embodiment according to the invention, first p-type diffused region 506 is coupled to a voltage line, for example Vdd.

FIG. 20B shows a control circuit 600 in accordance with one embodiment of the present invention. Control circuit 600 includes a resistor 602, a capacitor 604, and an output terminal 606. The resistor-capacitor circuit formed by resistor 602 and capacitor 604 provides a time delay of approximately 1 microseconds, longer than a typical ESD pulse of 150 ns to 300 ns. Control circuit 600 is coupled between a first voltage line, for example, Vdd, and a second voltage line, for example, Vss. Output terminal 606 is coupled to gates 522 and 532 shown in FIG. 20A. An ESD protection formed by SCR 500 and control circuit 600 as a whole is similar to ESD protection circuit 82 or 184 respectively shown in FIGS. 5 and 9.

Referring to FIGS. 20A and 20B, during normal operations, gates 522 and 532 are biased at a high voltage level, Vdd. P-type transistor 520 is turned off and n-type transistor 530 is turned on. Control circuit 600 exhibits a smaller resistance than the substrate resistance of SCR 500 due to the turn-on of n-type transistor 530. The holding voltage of SCR 500 is raised to a value above Vdd so that SCR 500 is kept from latching-up.

During an ESD event, gates 522 and 532 are biased at a low voltage level, Vss due to a time delay provided by the resistor-capacitor circuit. P-type transistor 520 is turned on and n-type transistor 530 is turned off. Control circuit 600 exhibits a greater resistance than the substrate resistance of SCR 500 due to the turn-off of n-type transistor 530. The holding voltage of SCR 500 is lowered to below Vdd to keep SCR 500 in the latch-up state to discharge an ESD current.

FIG. 21 shows an ESD protection circuit 620 in accordance with another embodiment of the present invention. ESD protection circuit 620 includes an SCR 500, a PMOS transistor 520, an NMOS transistor 530, and a control circuit 600. Control circuit 600 is coupled between a first voltage line Vdd and a second voltage line Vss. SCR 500 is coupled between a contact pad 550 and second voltage line Vss. PMOS and NMOS transistors 520 and 530 are formed integrally with SCR 500.

During normal operations, control circuit 600 provides a first voltage level Vdd to PMOS and NMOS transistors 520 and 530, which in turn provide a first holding voltage greater than Vdd to SCR 500 to keep SCR 500 from latching-up.

During an ESD event, for example, when a positive ESD pulse appears on contact pad 550 and second voltage line Vss is grounded, control circuit 600 provides a second voltage level Vss to PMOS and NMOS transistors 520 and 530, which in turn provide a second holding voltage smaller than Vdd to SCR 500 to keep SCR 500 in the latch-up state. The ESD pulse is discharged from contact pad 550 to second voltage line Vss.

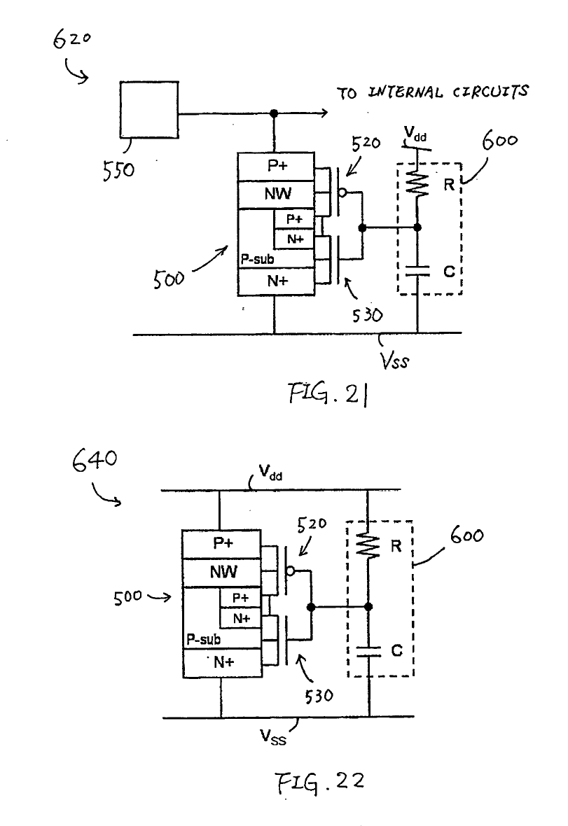

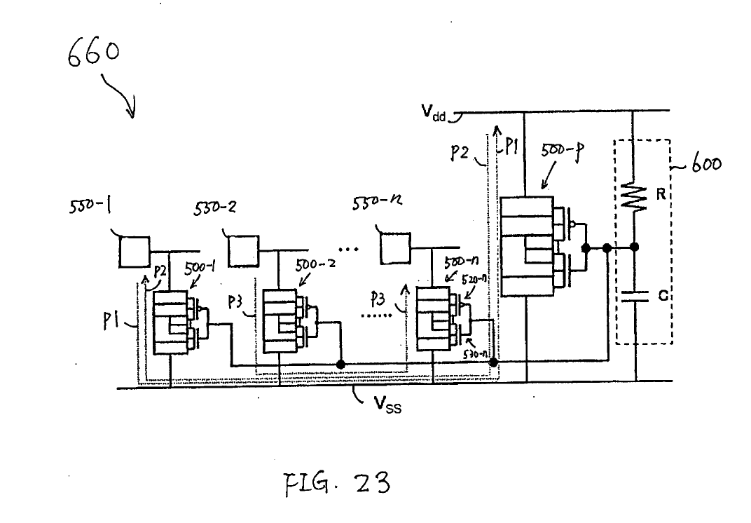

FIG. 22 shows an ESD protection circuit 640 in accordance with still another embodiment of the present invention. ESD protection circuit 640 has a similar structure to ESD protection circuit 620 except that SCR 500 is coupled between first voltage line Vdd and second voltage line Vss. During an ESD event, for example, when a positive ESD pulse appears on first voltage line Vdd and second voltage line Vss is grounded, control circuit 600 provides a second voltage level Vss to PMOS and NMOS transistors 520 and 530, which in turn provide a second holding voltage smaller than Vdd to SCR 500 to keep SCR 500 in the latch-up state. The ESD pulse is discharged from first voltage line Vdd to second voltage line Vss.

FIG. 23 shows an ESD protection circuit 660 in accordance with yet another embodiment of the present invention. ESD protection circuit 660 includes a plurality of SCRs 500-1, 500-2 . . . 500-n and 500-p, and a control circuit 600. An exemplary SCR 500-n includes a PMOS transistor 520-n and an NMOS transistor 530-n formed integrally with SCR 500-n. Control circuit 600 includes an output terminal 606 coupled to the gates (not numbered) of the PMOS and NMOS transistors of the SCRs. SCR 500-p is coupled between a first voltage line Vdd and a second voltage line Vss. Each of SCRs 500-1, 500-2 . . . 500-n is coupled between a corresponding contact pad 550-1, 550-2 . . . 550-n and second voltage line Vss.

During normal operations, control circuit 600 provides a first holding voltage through the PMOS and NMOS transistors to SCRs 500-1, 500-2 . . . 500-n and 500-p to keep these SCRs from latching-up.

If a positive ESD pulse appears on one of the contact pads, for example, contact pad 550-1 and first voltage line Vdd is grounded, control circuit 600 provides a second holding voltage through the PMOS and NMOS transistors to SCRs 500-1, 500-2 . . . 500-n and 500-p to keep these SCRs in the latch-up state. The ESD pulse is discharged in a first path P1 from contact pad 550-1 via second voltage line Vss to first voltage line Vdd.

If a positive ESD pulse appears on first voltage line Vdd and one of the contact pads, for example, contact pad 550-1, is grounded, control circuit 600 provides a second holding voltage through the PMOS and NMOS transistors to SCRs 500-1, 500-2 . . . 500-n and 500-p to keep these SCRs in the latch-up state. The ESD pulse is discharged in a second path P2 from first voltage line Vdd via second voltage line Vss to contact pad 550-1.

If a positive ESD pulse appears on one of the contact pads, for example, contact pad 550-2 and another contact pad, for example, contact pad 550n, is grounded, control circuit 600 provides a second holding voltage through the PMOS and NMOS transistors to SCRs 500-1, 500-2 . . . 500-n and 500-p to keep these SCRs in the latch-up state. The ESD pulse is discharged in a third path P3 from contact pad 550-2 via second voltage line Vss to contact pad 550-n.

The present invention also provides a method of ESD protection. An SCR having a holding voltage is provided. A PMOS transistor and an NMOS transistor are formed integrally with the SCR. The PMOS and NMOS transistors respectively include a first gate and a second gate. During a first condition, a first signal is provided to the first and second gates to raise the holding voltage of the SCR to keep the SCR from latching up. During a second condition, a second signal is provided to the first and second gates to lower the holding voltage of the SCR to keep the SCR in the latch-up state.

In another embodiment according to the invention, a method of ESD protection comprises providing a first voltage line of a first voltage level and a second voltage line of a second voltage level different from the first voltage level. A plurality of contact pads are provided. A plurality of SCRs are provided. Each of the SCRs includes a PMOS transistor and an NMOS transistor formed integrally with the SCR. The plurality of SCRs include at least one SCR coupled between the first and second voltage lines, and the remaining SCRs each being coupled between a corresponding contact pad and the second voltage line. During normal operations, a first holding voltage is provided through the PMOS and NMOS transistors to the SCRs to keep the SCRs from latching-up. During an ESD event, a second holding voltage is provided through the p-type and n-type transistors to the SCRs to keep the SCRs in the latch-up state.

In one embodiment, an ESD pulse is discharged from one of the contact pads via the second voltage line to the first voltage line. In another embodiment, an ESD pulse is discharged from the first voltage line via the second voltage line to one of the contact pads. In still another embodiment, an ESD pulse is discharged from one of the contact pads via the second voltage line to a different contact pad.

It will be apparent to those skilled in the art that various modifications and variations can be made in the disclosed process without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An integrated circuit for electrostatic discharge (ESD) protection comprising:
a silicon-controlled rectifier (SCR);
a first transistor of a first type integrally formed with the SCR including a first gate;
a second transistor of a second type integrally formed with the SCR including a second gate; and
a control circuit in response to a first voltage applied to the first and second gates providing a first holding voltage to the SCR to keep the SCR from latching-up, and in response to a second voltage applied to the first and second gates providing a second holding voltage to the SCR to keep the SCR in the latch-up state.

2. The circuit of claim 1, the control circuit further comprising an output terminal coupled to the first and second gates.

3. The circuit of claim 1, the control circuit further comprising a resistor, a capacitor and an output terminal disposed between the resistor and the capacitor.

4. The circuit of claim 1, the control circuit including a resistor-capacitor delay circuit.

5. The circuit of claim 1, the SCR further comprising a p-type substrate, an n-well formed in the p-type substrate, a p-type diffused region formed in the n-well, and an n-type diffused region formed outside of the n-well.

6. The circuit of claim 5, the first transistor further comprising a channel region formed in the n-well.

7. The circuit of claim 5, the second transistor further comprising a channel region formed in the p-type substrate.

8. An integrated circuit for electrostatic discharge (ESD) protection comprising:
a silicon-controlled rectifier (SCR);
a p-type transistor formed integrally with the SCR;
an n-type transistor formed integrally with the SCR;
a control circuit coupled to the p-type and n-type transistors providing a first holding voltage to the SCR to keep the SCR from latching-up, and providing a second holding voltage to the SCR to keep the SCR in the latch-up state.

9. The circuit of claim 8, the control circuit further comprising a resistor, a capacitor and an output terminal disposed between the resistor and the capacitor.

10. The circuit of claim 8, the control circuit further comprising an output terminal coupled to a gate of the p-type transistor and a gate of the n-type transistor.

11. The circuit of claim 8, the SCR further comprising a p-type substrate, an n-well formed in the p-type substrate, a p-type diffused region formed in the n-well, and an n-type diffused region formed outside of the n-well.

12. The circuit of claim 11, the SCR further comprising a different p-type diffused region partially formed in the n-well to serve as a drain of the p-type transistor, wherein the p-type diffused region serves as a source of the p-type transistor.

13. The circuit of claim 11, the SCR further comprising a different n-type diffused region formed in the p-substrate to serve as a drain of the n-type transistor, wherein the n-type diffused region serves as a source of the n-type transistor.

14. The circuit of claim 8, the SCR being coupled between a contact pad and a voltage line.

15. The circuit of claim 8, the SCR being coupled between different voltage lines.

16. An integrated circuit for electrostatic discharge (ESD) protection comprising:
a first voltage line of a first voltage level;
a second voltage line of a second voltage level;
a plurality of contact pads;
a plurality of silicon-controlled rectifiers (SCR), each of the SCRs including a p-type transistor and an n-type transistor integrally formed with the SCR; and
a control circuit providing a first holding voltage through the p-type and n-type transistors to the SCRs to keep the SCRs from latching-up, and providing a second holding voltage through the p-type and n-type transistors to the SCRs to keep the SCRs in the latch-up state during an ESD event that an ESD pulse appears on the first voltage line or one of the contact pads.

17. The circuit of claim 16, the SCRs further comprising at least one SCR coupled between the first and second voltage lines, and the remaining SCRs each being coupled between a corresponding contact pad and the second voltage line.

18. The circuit of claim 17, wherein during the ESD event, the ESD pulse is discharged from one of the contact pads via the second voltage line to the first voltage line.

19. The circuit of claim 17, wherein during the ESD event, the ESD pulse is discharged from the first voltage line via the second voltage line to one of the contact pads.

20. The circuit of claim 17, wherein during the ESD event, the ESD pulse is discharged from one of the contact pads via the second voltage line to a different contact pad.

21. The circuit of claim 16, the control circuit further comprising a resistor-capacitor delay circuit.

22. The circuit of claim 16, the control circuit further comprising an output terminal coupled to a gate of each of the p-type and n-type transistors.

23. A method of electrostatic discharge protection comprising:
providing a silicon-controlled rectifier (SCR) having a holding voltage;
integrally forming a first transistor of a first type with the SCR including a first gate;
integrally forming a second transistor of a second type with the SCR including a second gate; and
providing a first signal to the first and second gates to raise the holding voltage of the SCR to keep the SCR from latching up; and
providing a second signal to the first and second gates to lower the holding voltage of the SCR to keep the SCR in the latch-up state.

24. The method of claim 23 further comprising raising the holding voltage of the SCR to above a power supply voltage.

25. The method of claim 23 further comprising lowering the holding voltage of the SCR to below a power supply voltage.

26. The method of claim 23 further comprising coupling the SCR between a contact pad a voltage line.

27. The method of claim 23 further comprising coupling the SCR between different voltage lines.

28. A method of providing electrostatic discharge (ESD) protection for internal circuits comprising:
providing a first voltage line of a first voltage level;
providing a second voltage line of a second voltage level;
providing a plurality of contact pads;
providing a plurality of silicon-controlled rectifiers (SCR), each of the SCRs including a p-type transistor and an n-type transistor formed integrally with the SCR; and
providing a first holding voltage through the p-type and n-type transistors to the SCRs to keep the SCRs from latching-up, and
providing a second holding voltage through the p-type and n-type transistors to the SCRs to keep the SCRs in the latch-up state during an ESD event that an ESD pulse appears on the first voltage line or one of the contact pads.

29. The method of claim 28 further comprising providing the SCRs including at least one SCR coupled between the first and second voltage lines, and the remaining SCRs each being coupled between a corresponding contact pad and the second voltage line.

30. The method of claim 29 further comprising discharging the ESD pulse from one of the contact pads via the second voltage line to the first voltage line.

31. The method of claim 29 further comprising discharging the ESD pulse from the first voltage line via the second voltage line to one of the contact pads.

32. The method of claim 29 further comprising discharging the ESD pulse from one of the contact pads via the second voltage line to a different contact pad.
